(19) United States
(12) Patent Application Publication
(10) Pub. No.: US 2006/0159239 A1
(43) Pub. Date: Jul. 20, 2006

(54) Telephone call center distribution system and method

(76) Inventor: Robert E. Hughes JR., Greenville, SC (US)

Correspondence Address: MCNAIR LAW FIRM, P.A., P.O. BOX 10827, GREENVILLE, SC, 29603-0827, US

(21) Appl. No.: 11/036,808

(22) Filed: Jan. 14, 2005

(51) Int. Cl. H04M 1/64; H04M 15/00

(52) U.S. Cl. 379/87; 379/114.01

(57) ABSTRACT

A system and method for distributing a large number of phone calls to individual contacts using private phone lines in an efficient and simple manner by providing a database of contacts with their names and associated phone numbers, providing a plurality of remote computers associated with private phone lines for initiating phone calls to the contacts, transmitting a message to be played to the potential contacts to the remote computers, transmitting a list of the contacts and phone numbers to the remote computers, and initiating phone calls to the phone numbers over the private phone lines.

### FIELD OF THE INVENTION

This invention is directed to a system for distributing a large number of telephone calls from a telephone call center using remote personal computers.

### BACKGROUND OF THE INVENTION

Telephone call centers are typically used to distribute phone calls to a large number of people nationally, regionally, and/or locally. The number of phone lines and amount of machine systems can be very large and expensive. Private services can also be used for messaging, soliciting, polling, etc., which are typically expensive.

For example, one key method of attracting voters for political candidates is the use of phone banks for calling potential voters. Under this system a candidate or a political party purchases multiple phone lines and has volunteers use these multiple phone lines for calling potential voters to encourage them to vote for a particular candidate on election day. Many volunteers are leery to do this as they do not care for cold calling potential voters due to the fear of potential hang-ups or negative responses. Further, the purchase of several phone lines can be cost-prohibitive for a candidate or political party.

The use of pre-recorded messages has become more popular in recent years. Using a pre-recorded message from a candidate an auto dialing phone calls a list of phone numbers for potential voters and plays the message. While this system removes the necessity of using a volunteer, the candidate or party still must purchase the expensive multiple phone lines in order to call multiple voters. In addition to the expense of the phone lines, multiple auto dialers must be purchased in order to make use of the multiple phone lines. Several attempts have been made at using remote locations in a centralized server in running a call center. U.S. Patent Application Publication No. 2003/0202649 to Haug, Jr. discloses a Call Center Management System. This call center management system can be used to facilitate a political campaign and is a program for use in a traditional call center.

U.S. Pat. No. 6,320,956 to Cherry discloses a Multiple Client Remote Agent Network Method. The disclosed method allows remotely located agents to physically receive information from a network coordinator, and then make personal calls as per the coordinator's instructions. The system uses remote agents while having integrated data monitoring by the network coordinator but requires a user of the computer to make the phone calls individually.

### SUMMARY OF THE INVENTION

The invention is directed to a telephone call system for distributing large numbers of phone calls to individual contacts in a simple and efficient manner without the use of purchased commercial phone lines. The telephone call system comprises a first computer readable medium, a modem in communication with the first computer readable medium, a second computer readable medium in communication with the first computer readable medium, contact information in communication with at least one of the first or second computer readable mediums representing phone numbers for potential contacts. Additionally, the system incorporates message information in communication with one of either the first or second computer readable medium representing a message to be played, a first set of computer readable instructions in communication with the first computer readable medium which includes connection instructions for connecting to the second computer readable medium. The connection instructions include receiving instructions for receiving at least one phone number associated with a potential contact to call, call instructions for initiating a phone call to the phone number to be called with the modem and determining if the phone has been answered once the call has been made. The connection instructions include instructions for receiving message information, transmitting instructions for transmitting the message information.

The second set of computer readable instructions in communication with the second computer readable medium includes message transmission instructions for transmitting the message information, phone number instructions for selecting a phone number and selecting a recipient for the phone number and phone number transmission instructions for transmitting the phone number to the first computer readable medium.

The first set of computer readable instructions may further include status instructions for transmitting status information associated with the results of the phone call to the second computer readable medium and the second set of computer readable instructions include status instructions for receiving information from the first computer readable medium representing effectiveness.

The phone number instructions may include instructions for selecting a plurality of phone numbers, creating a list of the selected phone numbers, and transmitting the list of phone numbers to the first computer readable medium.

The call instructions may further include instructions for determining a time period that the computer readable medium, the modem, and a phone line associated with the modem will be made available to the set of computer readable instructions. The call instructions include instructions for determining if the time period allotted for use by the set of computer readable instructions has begun, initializing the modem, and initiating a phone call to the received phone number. Additionally, the call instructions include instructions for determining if the predetermined time period has ended, and stopping any future phone calls from being made by the set of computer readable instructions through the modem.

The message information may include first and second messages, wherein the first message represents information for transmitting upon an answer by an individual, and the second message represents information for transmitting upon an answer by an answering machine. The call instructions may further include instructions for determining if an individual or an answering machine has answered the phone call, and transmitting the message information associated with whatever type of answer has been made.

The message information includes information representing a poll which is taken by a recipient of the message via inputting touch tone signals on their telephone. Further, the call instructions include instructions for receiving signals from a user indicating a response to a question asked on the message information, compiling responses from users, and transmitting the responses to the second computer readable medium.

The first set of computer readable instructions may further include verification instructions for verifying the phone number associated with a potential contact. The verification instructions may utilize Web resources.

The telephone call system is a system for distributing large numbers of phone calls to individual contacts in a simple and efficient manner without the use of purchased commercial phone lines. The system comprises a computer program, a computer readable medium and a set of computer readable instructions in communication with the computer readable medium. The computer readable medium includes receiving instructions for receiving a plurality of phone numbers associated with potential contacts pre-selected from a database of potential contacts from a second computer readable medium, call instructions for initiating a phone call over a private phone line to the phone number and determining if the phone has been answered.

Additionally, the computer readable medium includes message receiving instructions for receiving message information from a second computer readable medium; message transmission instructions for transmitting the message information to the phone associated with the phone number and the ability to determine if the message information has completed being transmitted.

The set of computer readable instructions may further include status instructions for transmitting status information associated with the results of the phone call to a second computer readable medium which comprises a modem in communication with the computer readable medium and the call instructions including instructions for initializing the modem and initiating a phone call to a received phone number with the modem.

The call instructions may further include instructions for determining a time period that the computer readable medium, the modem, and the private phone line associated with the modem will be made available to the set of computer readable instructions. Further, the call instructions include instructions for determining if the time period allotted for use by the set of computer readable instructions has begun, and initiating the sequence of initializing the modem, and dialing the first of the plurality of received phone numbers.

The call instructions may further include instructions for determining if the predetermined time period has ended, and stopping any future phone calls from being made by the set of computer readable instructions through the modem over the private phone line. The message information may also contain first and second messages, the first message representing information for transmitting upon an answer by an individual, and the second message representing information for transmitting upon an answer by an answering machine.

Further, the call instructions include instructions for determining if an individual or an answering machine has answered the phone call and transmitting the message information associated with the type of answer as having been made.

The system message information includes information representing a poll which is taken by a recipient of the message via inputting touch tone signals on their telephone. The set of computer readable instructions include instructions for receiving signals from a user indicating a response to a question asked on the message information, compiling responses from users, and transmitting the responses to the second computer readable medium.

The set of computer readable instructions include verification instructions for verifying the phone number associated with a potential contact, wherein the verifying of a contact's phone number is done using Web resources.

The present invention comprises a method for distributing a large number of phone calls to individual contacts using private phone lines in an efficient and simple manner comprising providing a database of contacts with their names and associated phone numbers, providing a plurality of remote computers associated with private phone lines for initiating phone calls to the contacts, transmitting a message to be played to the potential contacts, transmitting a list of the contacts and phone numbers to the remote computers and initiating phone calls to the phone numbers over private phone lines.

Phone calls to the phone numbers using the remote computers' telephone capabilities and playing the message to the recipient of the phone call.

The system determines if the message completed playing prior to the termination of the phone call and recording status information based on the determination of message completion, provides a message for play should an answering machine answer the phone and a message for play if an individual answers the phone, determines if an individual or an answering machine has answered the phone call and plays the selected message based on the determination of if an individual or answering machine has answered the phone.

Each remote computer determines a calling time window that each remote computer and its associated private phone line will be available. The remote computer whether or not the calling time window has opened prior to initiating any phone calls and determines if the calling time window has closed and if so, ceases any future calls from being made. The phone number associated with a contact's name is verified so that only the desired contacts are called.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a schematic illustrating the components of the telephone call center distribution system;

FIG. 2 is a schematic further illustrating the components of the system;

FIG. 3 is a data flow diagram illustrating the flow of data between a remote computer and the server;

FIG. 4 is a flow chart illustrating the installation, initialization and operation of the system; and

FIG. 5 is a flow chart illustrating the operation of the system.

### DESCRIPTION OF A PREFERRED EMBODIMENT

Referring now in more detail to the drawings, the invention will now be described in more detail.

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated by a set of computer readable instructions embodied in a computer readable medium that is designed to perform a specific task or tasks. Actual computer or executable code or computer readable code may be contained within one file or one storage medium but may also span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block, or step of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The term media is used to include audio, video, animation or any other form audio or visual information. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

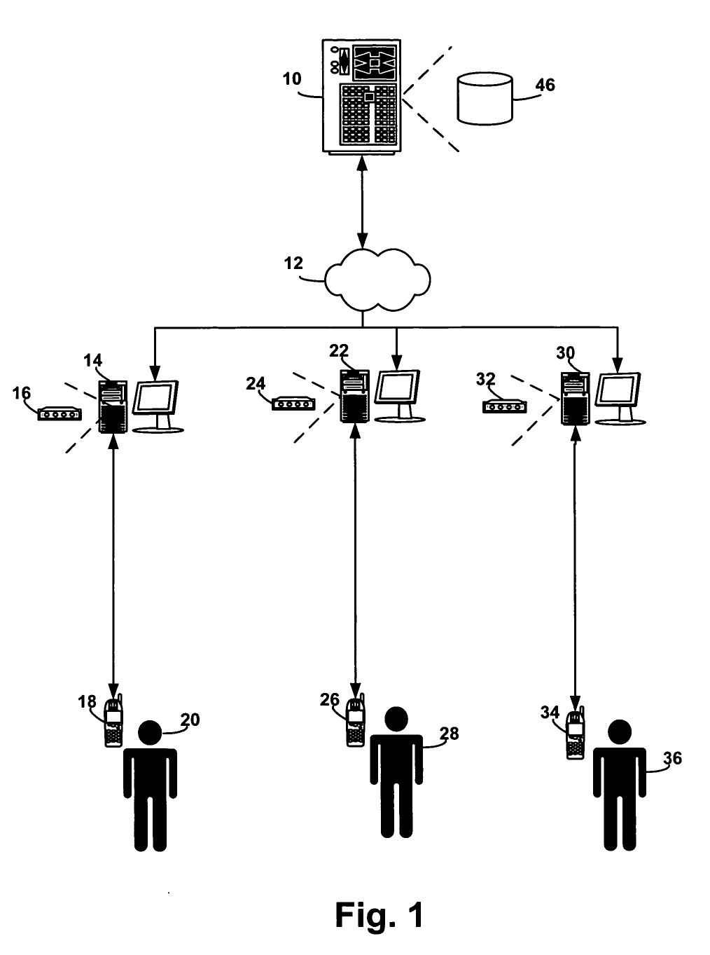

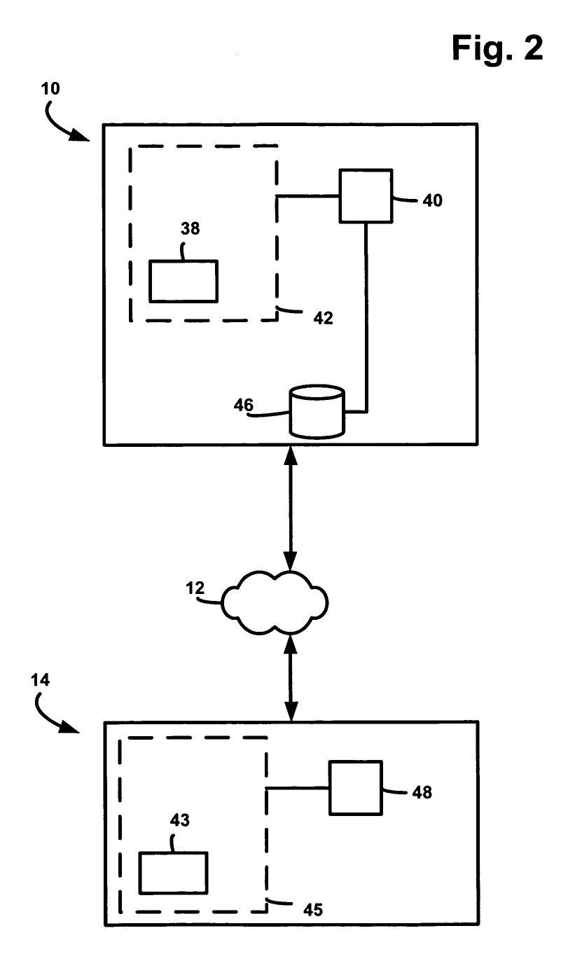

As can best be seen in to FIGS. 1 and 2, the components of the invention are described in more detail. The system operates using server 10 to communicate with multiple remote computers. Server 10 communicates with the remote computer through network 12. Multiple remote computers, such as 14, 22, 30, may be used and are shown in FIG. 1. Server 10 can contain contact information which can be stored in database 46. Alternatively, contact information may be stored in a medium in communication with server 10. Contact information may include a variety of different information. In the case of a retail store, contact information may include customer information. The customer information includes the names and phone numbers and additional information about the existing or potential customers of a store.

While having other applications, the present invention is particularly advantageous for use in contacting voters in a political campaign. Accordingly, for purposes of illustration only, the illustrated embodiment will be described in terms of a political application. In this case, contact information includes voter information for use in a political campaign. For ease of explanation, voter information is described in more detail below. Voter information can include the names, phone numbers, addresses, and additional information about potential voters. Each associated remote computer may have software installed for communicating with server 10, and performing the functions associated with the system. Further embodiments, the remote computers need not have any software installed on them. Rather, they would operate as dumb terminals; communicating with server 10 wherein the program for operating the system would be located, and displaying the output of the program to a user. In a further embodiment, all associated remote computers must be in communication with a modem. As used in this patent application, the term modem includes modulation/ demodulation devices, hardware devices, software devices allowing for communication between computers and telephones and voice-over IP technology in both hardware and software form. For example, remote computer 14 is in communication with modem 16. Each remote computer is associated with a private phone line which is used in making calls.

As can best be seen in FIG. 2, the components of computers 10 and 14 will be described below. Computer 10 includes program 38 which consists of one or more of sets of computer readable instructions residing in computer readable memory 42. These instructions may include message transmission, phone number, and phone number transmission instructions. In communication with computer readable memory 42 is processor 40. Processor 40 processes the set of computer readable instructions 38 in order to achieve the desired results. Further, database 46 can be included in a further embodiment in communication with processor 40. Database 46 may include potential voter information which is retrieved via instructions processed by processor 40. Computer 10 communicates to computer 14 through network 12. Network 12 can be a local area network, a wide area network, or any other type of communications. Computer 14 is similar in structure as computer 10 in that a set of computer readable instructions 43 resides in computer readable memory 45. Computer readable memory 45 is in communication with processor 48. Processor 48 processes the computer readable instructions 43 in order to achieve the desired results. Those instructions may include connection, receiving, call, message receiving, transmission, and status instructions.

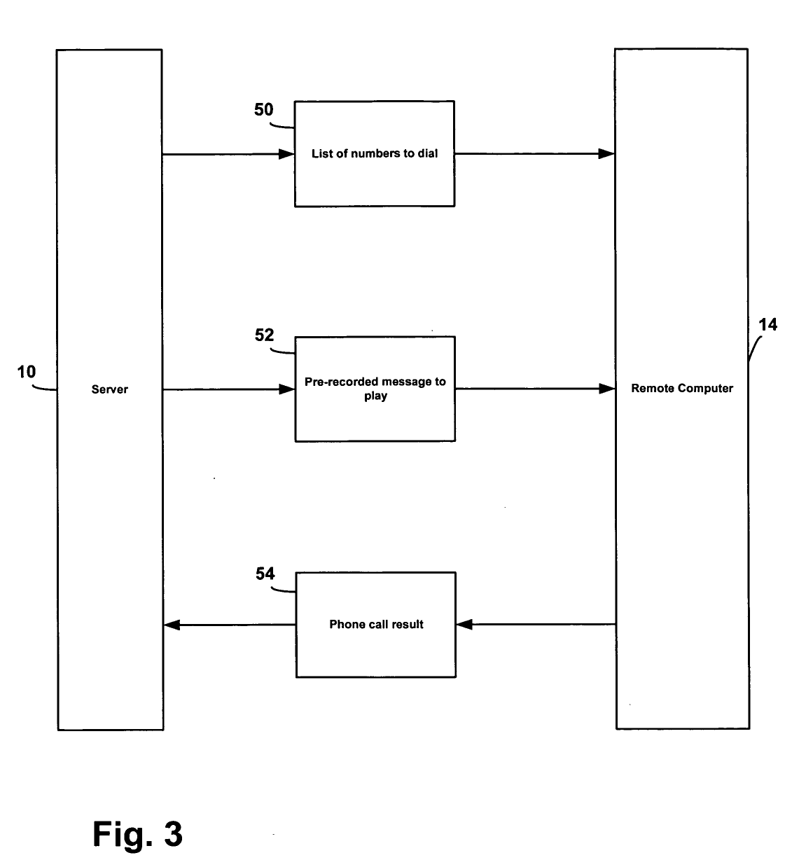

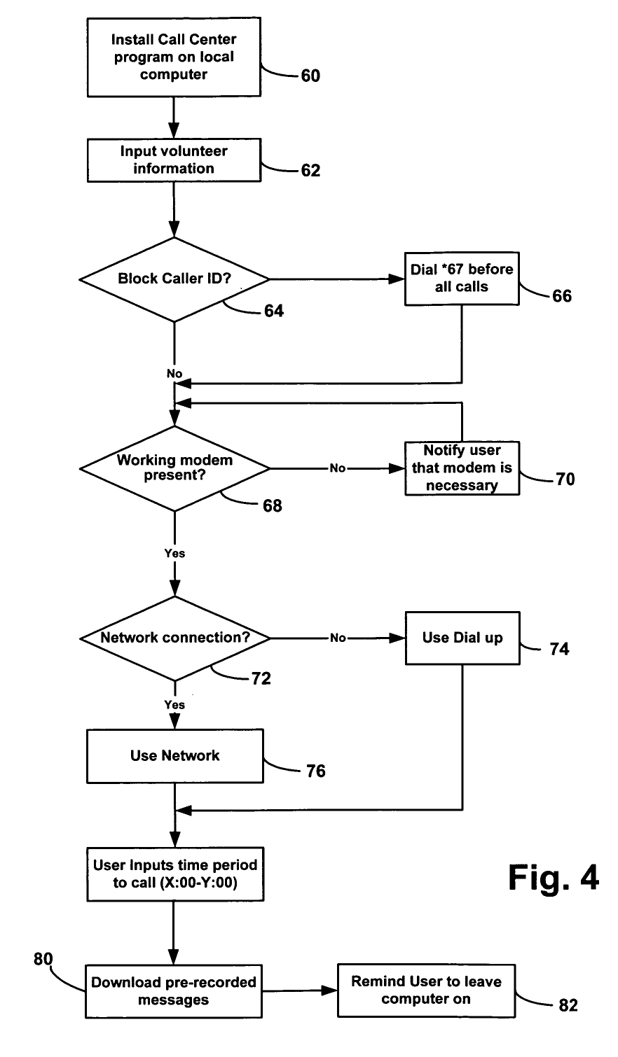

Server 10 may transmit voter information through network 12 to computers 14, 22 and 30. For illustrative purposes only, computer 14's operation is described only. Computers 22 and 30 can operate in a similar manner as computer 14. A user of computer 14 may enter in a specific time that the phone line of that user's house, place of business, or other location of phone, will be available to make calls over the user's private phone line. Prior to that time period, the data representing the phone numbers for potential voters may be sent to computer 14 by server 10 through network 12. Once the time has come to make the phone calls, computer 14 may use modem 16 to make phone calls to potential voter 20. Prior to making these phone calls, server 10 may transmit pre-recorded phone calls to computer 14 via network 12. Upon potential voter 20 answering their phone 18, computer 14 begin playing the pre-recorded message for user 20 via modem 16. The operation of the system is described more fully in the data flow diagram FIG. 2, and flow charts FIGS. 3 and 4. This operation is described in more detail below.

As can best be seen in FIG. 3, a data flow diagram is shown describing the flow of data between server 10 and one of the remote computers, 14. Remote computer 14 may receive a list of numbers to dial from server 10. This list would preferably include numbers in the local calling area of remote computer 14 so as to avoid any long distance charges. Server 10 also may transmit pre-recorded message 52 to remote computer 14. In a further embodiment there can be multiple pre-recorded messages for the answer of an individual, and the answer by an answering machine. Remote computer 14 may determine if an individual had answered the call, or if an answering machine had answered the call prior to determining which of the pre-recorded messages to play. Upon the conclusion of the phone calls made by remote computer 14, remote computer 14 may transmit phone call result information 54 to server 10. Server 10 may then associate this information with voter information located on server 10. For calls that were not successfully completed, server 10 may continue to place this voter as someone to call in the future, and transmit their phone number to future remote computers.

In a further embodiment, remote computer 14 may have verification instructions that use a network connection to access web resources to error check the list of phone numbers 50 received. An online phone book service such as that offered by Yahoo or Google can be used to verify if the name and address associated with the phone number are still accurate. If any changes have been made to the phone number, the person owning the phone number, or the address associated with the phone number, remote computer 14 may update the list of numbers and transmit it to server 10 for verification and any correction as needed.

The calling system may be used for polling as well as for use with playing pre-recorded messages. Messages can include branches that are selected by touch tones caused by user 20 using touch tone phone 18. A question could be asked of a user 20, who would respond using the numeric key pad on phone 18. Remote computer 14 would record any touch tones keyed in by user 20, and transmit this information representing polling data to server 10. Server 10 could then associate that polling data with other polling data received from individuals called by other remote computers (22, 30, 38) and create a statistical profile of potential voters.

Referring to FIG. 4, a flow chart is shown detailing the installation, initialization and operation of the software on a client computer such as client computer 14. At step 60, the user may install the call center program. The installation can be accomplished via an auto run program on an associated computer disk, including but not limited to a CD, DVD, floppy disk, flash memory, thumb drive, etc. Alternatively, the program may be available for download via the internet. Upon downloading, the user installs the program on to their computer using an install program downloaded from the website. At step 62, the user inputs their volunteer information into the installed call center distribution program. This input, and all later input, can be input through associated text boxes, check boxes, radio controlled buttons, clickable icons, and all other known forms of inputting information or data into a computer program. At step 64, the system may ask the user if they wish to block caller ID functionality for the phone calls made. If so, then at step 66, the system can require *67 be dialed before each call. After performing this operation, or if no blocking of caller ID is needed, the system then checks for a working modem at step 68. A modem is required in a further embodiment in order to make the associated phone calls. As defined above, voice-over IP and other communication systems are included by the term modem. If no working modem is found at step 68, then the user is notified that a working modem is required to use this system at step 70. If a modem is found at step 68, then the system determines if a network connection is available at step 72. If no network connection is available, then at step 74 the system will use at dial-up connection for future activities. If a network connection is available at step 72, then the system will use a network connection at step 76 for future activities.

After performing these initial operations, the system then begins the process of determining what time the associated private phone line may be used, downloading potential phone numbers to call, and downloading pre-recorded messages to play to potential voters. At step 78, the user is asked to input a time for which the private phone line may be used by the system. The time must be between hours desired by this system to make phone calls to potential voters. The user then inputs an acceptable time at step 78 between those time restrictions. Once the time for use has been determined, then at step 80 the system receives a list of potential callers to be called during the time period input, a schedule with which to call those numbers, and at least one voice message. One of the voice messages may be used if an individual answers the phone, and another may be used if an answering machine answers the phone. Once those items have been downloaded, the user may be reminded to leave their phone turned on and connected to their private phone line and the Internet during that time period, generally indicated as X:00-Y:00.

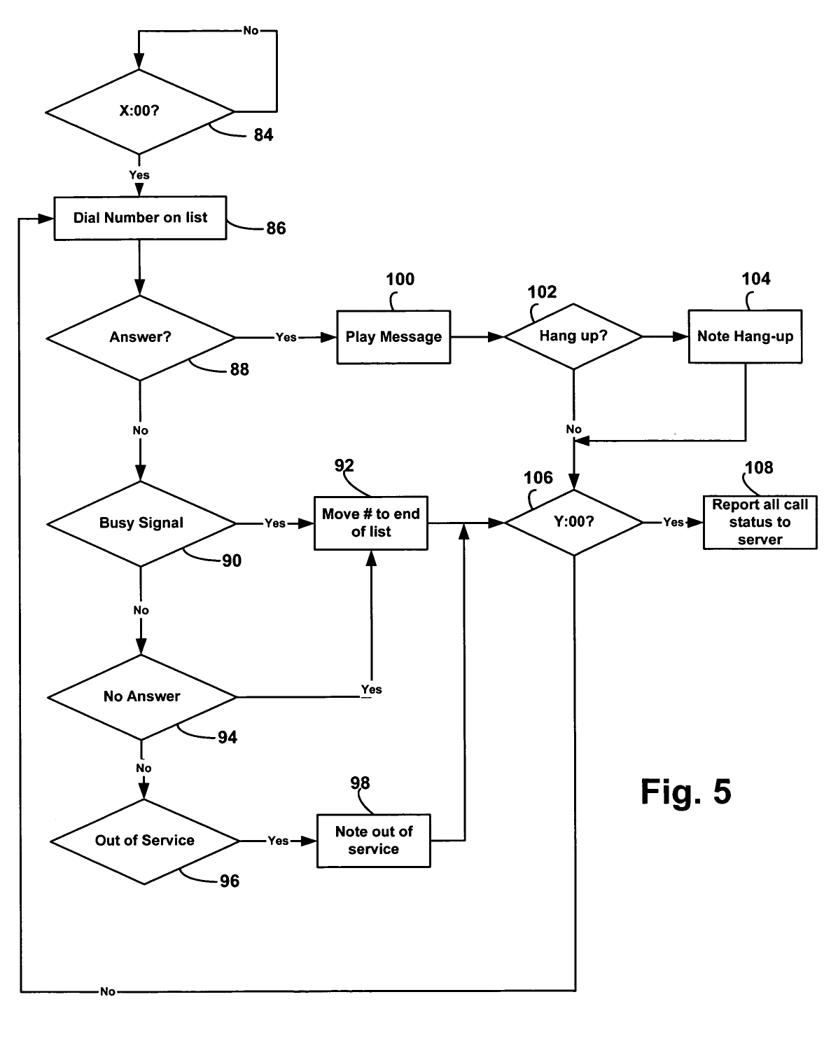

Referring now to FIG. 5, the operation of the system is further described. The system may determine if it is X:00 yet at step 84. If it is, then at step 86, the system initiates a call to the first number on the list. The system determines if there is an answer at step 88. If no answer the system determines if the phone is busy at step 90, if the phone line is busy at step 90, then that number may be moved to the end of the list at step 92. At that point, the system determines if it is Y:00. If it is Y:00, then the system may not make further phone calls and reports to the server the status of all phone calls made, at step 108. If it is not Y:00, the system returns to step 86 and initiates a call to the next number on the list. If the phone number is not busy at step 90, the system determines if no answer was made at step 94. If no answer was made at step 94, the system returns to step 92 to move the phone number to the end of the list and performs as described above with a busy signal. If the phone is out of service at step 96, a notation of this is made at step 98 and the system then behaves as described above for the busy signal. If an answer is made at step 88, then the system plays a message step 100. In a further embodiment, if it is determined that it is an answering machine the system will play the voice message designated for answering machines upon receiving the beep on an answering machine. If an individual answers, then the system may pause very briefly and then plays the message. During the playing of the message, if the receiver of the phone calls hangs up at step 102, then a note is made of the hang-up at step 104. After making the note, or in the case of there being no hang-up at the conclusion of the message, the system determines at step 106 if it is Y:00. If it is not Y:00, the system returns to step 86 and initiates the next number on the list. If it is Y:00, then the system advances to 108, and may make no further phone calls, and reports to the server the status of each phone call that was made.

Upon receiving the information as to the status of each phone call made, server 10 removes the numbers associated with successful calls, or the hang-up calls from voters to call from voter information 46. The other calls that were not successfully completed may be queued as potential voters to call and transmitted to future remote computers for calling. The calls associated with disconnected or incorrect phone numbers may be separated and error-checked to determine the appropriate phone numbers for those individuals. This error-checking may be done manually, using web resources automatically by the system, or other known means for validating phone numbers. Once these phone numbers have been changed, they are included in the queue of potential voters to call. Note that if polling data has been collected by the messages, server 10 includes instructions for assimilating the data into percentages to determine the results of polling questions based on responses from potential voters.

In an alternative embodiment, the list of numbers to dial and the pre-recorded messages to play may be included on a computer readable medium such as a CD and given to volunteers. The volunteers would then input the computer readable medium into their computer. Upon entering this information into the computer via the CD, the program can access this list of numbers and operate as described above.

The above operation was described using voter information and potential voters as an example. The system may be used similarly to contact potential customers for a retail store or a service provider. The pre-recorded message in this instance could be an advertisement for a sale the store is having or other information associated with a retail store or a service provider. The list of contact information would be potential customer or existing customer information. The system would then contact each of these potential customers and play the message associated with the retail store or service provider. The polling function described above could also be used in the retail or service provider environment as well. Customer service surveys are routinely necessary, and can be carried in a more efficient manner in using the system.

As shown above, the invention provides a call system which is cost efficient, yet allows a large number of calls to be made without the expenses associated with expensive machines and telephone lines. The invention allows small business owners to market their products and political campaigns to distribute campaign messages, and all others to communicate with potential contacts in a simple and cost efficient manner.

While a preferred embodiment of the invention has been described using specific terms, such description is for illustrative purposes only, and it is to be understood that changes and variations may be made without departing from the spirit or scope of the following claims.

What is claimed is:

1. A telephone call system for distributing large numbers of phone calls to individual contacts in a simple and efficient manner without the use of purchased commercial phone lines comprising:
a first computer readable medium;
a modem in communication with said first computer readable medium;
a second computer readable medium in communication with said first computer readable medium;
contact information in communication with at least one of said first and said second computer readable medium representing phone numbers for potential contacts;
message information in communication with at least one of said first and said second computer readable medium representing a message to be played;
a first set of computer readable instructions in communication with said first computer readable medium including:
connection instructions for connecting to said second computer readable medium;
receiving instructions for receiving at least one phone number associated with a potential contact to call;
call instructions for initiating a phone call to said phone number with said modem and determining if the phone has been answered;
message receiving instructions for receiving said message information;
transmitting instructions for transmitting said message information;
a second set of computer readable instructions in communication with said second computer readable medium including:
message transmission instructions for transmitting said message information;
phone number instructions for selecting a phone number and selecting a recipient for the phone number;
phone number transmission instructions for transmitting the phone number to said first computer readable medium.

2. The system of claim 1 wherein said first set of computer readable instructions include status instructions for transmitting status information associated with the results of the phone call to said second computer readable medium and said second set of computer readable instructions include status instructions for receiving information from said first computer readable medium representing effectiveness.

3. The system of claim 1 wherein said phone number instructions include instructions for selecting a plurality of phone numbers, creating a list of the selected phone numbers, and transmitting the list of phone numbers to said first computer readable medium.

4. The system of claim 1 wherein said call instructions include instructions for determining a time period that said computer readable medium, said modem, and a phone line associated with said modem will be made available to said set of computer readable instructions.

5. The system of claim 4, wherein said call instructions include instructions for determining if the time period allotted for use by said set of computer readable instructions has begun, initializing said modem, and initiating a phone call to the received phone number.

6. The system of claim 4, wherein said call instructions include instructions for determining if the predetermined time period has ended, and stopping any future phone calls from being made by said set of computer readable instructions through said modem.

7. The system of claim 1, wherein said message information includes first and second messages, said first message representing information for transmitting upon an answer by an individual, and said second message representing information for transmitting upon an answer by an answering machine.

8. The system of claim 7, wherein said call instructions include instructions for determining if an individual or an answering machine has answered the phone call, and transmitting said message information associated with whatever type of answer has been made.

9. The system of claim 1, wherein said message information includes information representing a poll which is taken by a recipient of the message via inputting touch tone signals on their telephone.

10. The system of claim 9, wherein said call instructions include instructions for receiving signals from a user indicating a response to a question asked on said message information, compiling responses from users, and transmitting the responses to said second computer readable medium.

11. The system of claim 1, wherein said first set of computer readable instructions include verification instructions for verifying the phone number associated with a potential contact.

12. The system of claim 11, wherein said verification instructions utilize Web resources.

13. In a telephone call system for distributing large numbers of phone calls to individual contacts in a simple and efficient manner without the use of purchased commercial phone lines, a computer program comprising:
a computer readable medium; and
a set of computer readable instructions in communication with said computer readable medium including:
receiving instructions for receiving a plurality of phone numbers associated with potential contacts pre-selected from a database of potential contacts from a second computer readable medium;
call instructions for initiating a phone call over a private phone line to said phone number and determining if the phone has been answered;
message receiving instructions for receiving message information from a second computer readable medium;
message transmission instructions for transmitting the message information to the phone associated with all said phone number and determining if the message information has completed being transmitted.

14. The system of claim 13 wherein said set of computer readable instructions include status instructions for transmitting status information associated with the results of the phone call to a second computer readable medium.

15. The system of claim 13 further comprising:
a modem in communication with said computer readable medium; and
said call instructions including instructions for initializing said modem, initiating a phone call to a received phone number with said modem.

16. The system of claim 13 wherein said call instructions include instructions for determining a time period that said computer readable medium, said modem, and the private phone line associated with said modem will be made available to said set of computer readable instructions.

17. The system of claim 16, wherein said call instructions include instructions for determining if the time period allotted for use by said set of computer readable instructions has begun, and initiating the sequence of initializing said modem, and dialing the first of the plurality of received phone numbers.

18. The system of claim 16, wherein said call instructions include instructions for determining if the predetermined time period has ended, and stopping any future phone calls from being made by said set of computer readable instructions through said modem over the private phone line.

19. The system of claim 13, wherein said message information contains first and second messages, said first message representing information for transmitting upon an answer by an individual, and said second message representing information for transmitting upon an answer by an answering machine.

20. The system of claim 19, wherein said call instructions include instructions for determining if an individual or an answering machine has answered the phone call, transmitting said message information associated with the type of answer has been made.

21. The system of claim 13, wherein said message information includes information representing a poll which is taken by a recipient of the message via inputting touch tone signals on their telephone.

22. The system of claim 21, wherein said set of computer readable instructions include instructions for receiving signals from a user indicating a response to a question asked on said message information, compiling responses from users, and transmitting the responses to said second computer readable medium.

23. The system of claim 13, wherein said set of computer readable instructions include verification instructions for verifying the phone number associated with a potential contact.

24. The system of claim 23, wherein the verifying of a contact's phone number is done using Web resources.

25. A method for distributing a large number of phone calls to individual contacts using private phone lines in an efficient and simple manner comprising:
providing a database of contacts with their names and associated phone numbers;
providing a plurality of remote computers associated with private phone lines for initiating phone calls to said contacts;
transmitting a message to be played to said potential contacts to said remote computers;
transmitting a list of said contacts and phone numbers to said remote computers;
initiating phone calls to the phone numbers over said private phone lines.

26. The method of claim 25 including the steps of:
initiating phone calls to the phone numbers using the remote computers'telephone capabilities; and
playing the message to the recipient of the phone call.

27. The method of claim 26 including the steps of:
determining if the message completed playing prior to the termination of the phone call;
recording status information based on the determination of message completion.

28. The method of claim 26 including the steps of:
providing a message for play should an answering machine answer the phone and a message for play if an individual answers the phone;
determining if an individual or an answering machine has answered the phone call; and
playing the selected message based on the determination of if an individual or answering machine has answered the phone.

29. The method of claim 25 including the steps of:
determining a calling time window that each remote computer and its associated private phone line will be available;
determining if the calling time window has opened prior to initiating any phone calls; and
determining if the calling time window has closed and it so, ceasing any future calls from being made.

30. The method of claim 25 including the step of:
verifying the phone number associated with a contact's name so that only the desired contacts are called.
